(19) United States
(12) Patent Application Publication
(10) Pub. No.: US 2016/0368029 A1
(43) Pub. Date: Dec. 22, 2016

(54) AUTOMATIC CLEANING OF SOLAR RADIATION SENSORS

(71) Applicant: AUGUSTYN + COMPANY, Berkeley, CA (US)

(72) Inventor: James Raymond Augustyn, Berkeley, CA (US)

(21) Appl. No.: 15/183,607

(22) Filed: Jun. 15, 2016

Related U.S. Application Data
(60) Provisional application No. 62/180,452, filed on Jun. 16, 2015.

(51) Int. Cl. B08B 3/02; B05B 7/02; G01J 1/42; B05B 3/06; B08B 3/08; B08B 5/02

(52) U.S. Cl. CPC B08B 3/02; B08B 3/08; B08B 5/02; G01J 1/42; B05B 3/06; B05B 7/02; G01J 2001/4266

(57) ABSTRACT

Systems and techniques are described herein for cleaning solar radiation sensors (e.g., radiometers). More specifically, various embodiments concern providing timed, recurring, and/or automatic cleaning of sensors by directing one or more streams of fluid (e.g., liquid and/or air) onto the outer surface of a sensor. For example, a mechanism can direct one or more streams of air onto the outer surface of the sensor to remove residual liquid and solid surface contaminants. Each stream of fluid can be applied in a steady, pulsed, or swirling manner. A cleaning system may include one or more delivery systems and one or more spray nozzle assemblies. The dispensing nozzle(s) in each spray nozzle assembly can be either fixed in their position relative to the corresponding sensor, or can be made to move during a cleaning operation to achieve optimal angles of fluid impingement upon the surface of the sensor.

### CROSS-REFERENCE TO RELATED APPLICATION(S)

This application claims the benefit of U.S. Provisional Patent Application No. 62/180,452, entitled “METHOD, SYSTEM AND APPARATUS FOR AUTOMATIC CLEANING OF SOLAR RADIATION SENSORS,” which was filed on Jun. 16, 2015, which is incorporated by reference herein in its entirety.

### RELATED FIELD

Various embodiments relate to sensors for measuring solar radiation arriving at the earth's surface and, more specifically, to improving the accuracy of such measurements by employing a system for cleaning the solar radiation sensors.

### BACKGROUND

Accurate and reliable measurement of the instantaneous intensity and the temporal, spatial, and spectral variability of solar radiation at the earth's surface are essential for the orderly development and effective ongoing support of solar energy conversion technologies at all scales. Such measurements are also essential to the continuing development of world climate computer models and to various specialties within the field of environmental science.

However, all solar radiation measuring sensors (e.g., radiometers) that are deployed for extended periods within the earth's atmosphere in unsheltered, outdoor conditions are susceptible to inaccurate measurements due to the build-up of dirt and debris on the outer surface of the radiometer's transparent or translucent dome, window, or light diffuser. The build-ups can reflect, refract, block, or attenuate the strength and nature of the electromagnetic signal that is to be measured by the radiometer's internal detector, thereby potentially causing undesired alteration of the measured values reported by the radiometer.

The most common operational approach to address this problem is to periodically clean the external surfaces of a radiometer's light-transmitting elements by hand. The most obvious drawback of this approach is the cost of labor and travel over extended time periods, particularly when the radiometer is located in a remote location. These costs are usually directly proportional to the frequency of cleaning events.

Electrically-driven fans have also been used to maintain a continuously moving layer of air over the transparent dome or flat glass optics of the radiometer to reduce deposits of foreign particles or ice. One significant drawback of this approach it that it requires considerable amounts of electrical energy, which is typically unavailable or prohibitively expensive to obtain in remote locations. Another drawback is the need to filter substantial volumes of air being blown onto the surface of the radiometer and the need to keep the filters clean, particularly in dusty environments. This approach is also typically limited to specific models of radiometer and cannot be readily adapted for use with other radiometers having different physical characteristics. Moreover, the layer of air may not prevent dust-entrained rain drops from landing on the radiometer's protective glass dome or other optical surfaces.

Systems and techniques for cleaning solar radiation sensors (e.g., radiometers) are described herein. More specifically, various embodiments concern providing timed, recurring, and/or automatic cleaning of different types of radiometers by directing one or more regulated streams of liquid onto the outer surface of a radiometer, and then directing one or more regulated streams of air onto the outer surface of the radiometer. The streams of liquid and air could be directed toward a light-transmitting dome or window, or a light-accepting diffuser.

The systems described herein can clean one or more solar radiometers for extended periods of time (e.g., six months or more) without requiring human interaction. Cleaning is accomplished by directing one or more streams of liquid (e.g., clean water or a non-freezing cleaning liquid) at each radiometer's window, diffuser, or dome, and then directing one or more streams of filtered air at each radiometer's window, diffuser, or dome to remove residual liquid and solid surface contaminants. Each stream of liquid or filtered air could be applied in a steady, pulsed, or swirling manner. Controls are provided to independently vary liquid and air flow velocities, length of flow times, and the time between cleaning cycles.

Accordingly, a radiometer cleaning system may include one or more fluid delivery systems and one or more spray nozzle assemblies. The fluid delivery systems store and propel liquid and air to the spray nozzle assemblies. The fluid delivery systems may be readily adjustable (e.g., field adjustable) and are capable of delivering regulated streams of liquid and/or air through one or more spray nozzle assemblies to clean the radiometer(s) within a solar radiation measuring station. Generally, one spray nozzle assembly is provided for each radiometer to be cleaned. However, multiple spray nozzle assemblies (e.g., one assembly for ejecting liquid and one assembly for ejecting air) could instead be provided for each radiometer.

The spray nozzle assemblies can be customized for each physically unique type of radiometer. Among these are: nozzle assembly designs for cleaning photodiode radiometers, including those incorporated within certain rotating shadow band radiometer systems; nozzle assembly designs for cleaning tracking pyrheliometer radiometers; nozzle assembly designs for cleaning horizontally and non-horizontally mounted pyranometer radiometers; and nozzle assembly designs for cleaning photovoltaic reference cells. Some nozzle assembly designs described herein provide an ability to securely mount, adjust azimuthal orientation, and adjust the level of a pyranometer radiometer (e.g., with respect to a horizontal plane) with greater control and ease than the features built into the radiometer by the original manufacturer.

The dispensing nozzle(s) in each spray nozzle assembly can be either fixed in their position(s) relative to the corresponding radiometer, or can be made to move during a cleaning operation to achieve optimal angles of fluid impingement upon the surface of the radiometer in order to effect optimal debris and residual liquid dislodgement and removal.

In some embodiments, the dispensing nozzle(s) change position during the cleaning operation using the energy contained in the moving fluid or air within the nozzle(s) to effect position change. Gravity is generally sufficient to cause the nozzle(s) to return to their original resting positions when fluid or air is no longer being dispensed. In other embodiments, changes in nozzle position are effected by electro-mechanical devices (e.g., motors, pistons, drives). Both fixed-position and moving nozzles do not obstruct the optical field of view of the corresponding radiometer(s) when not in use (i.e., when at rest and not cleaning).

Several embodiments of the cleaning systems described herein can be used to clean radiometers installed within new and/or existing solar radiation measurement stations and equipment intended for various purposes. For example, the cleaning systems described herein can be incorporated into facilities for generating solar power, facilities for solar power plant siting assessment and project development, and facilities for scientific research, industrial research, and development of solar energy related products and services.

Some embodiments of this disclosure have other aspects, elements, features, and steps in addition to or in place of what is described above. These potential additions and replacements are described throughout the rest of the specification.

### BRIEF DESCRIPTION OF THE DRAWINGS

One or more embodiments of the present invention are illustrated by way of example and not limitation in the figures of the accompanying drawings, in which like references indicate similar elements.

FIG. 1A depicts a fluid delivery and control system (also referred to as a “cleaning system”) for cleaning solar radiation sensors (e.g., radiometers), in accordance with various embodiments.

FIG. 1B depicts a block diagram of components of the cleaning system, in accordance with various embodiments.

FIG. 2A depicts a spray nozzle assembly for cleaning a photodiode pyranometer shown in its mounting position affixed to the underside of the pyranometer's combination motor housing and photodiode pyranometer mounting arm, in accordance with various embodiments.

FIG. 2B depicts the spray nozzle assembly for cleaning the photodiode pyranometer without showing the pyranometer's combination motor housing, in accordance with various embodiments.

FIG. 3A depicts a spray nozzle assembly that is delivering a single, steady stream of liquid to the light-accepting diffuser of a pyranometer, in accordance with various embodiments.

FIG. 3B depicts the spray nozzle assembly for cleaning the photodiode pyranometer after liquid delivery has been completed and as the rightmost moveable nozzle has begun its movement into position to eject air to dislodge residual liquid deposited on the pyranometer, in accordance with various embodiments.

FIG. 4A depicts a pyranometer assembly including a thermopile pyranometer mounted on an azimuthally-orientable and level-adjustable base block having fixed delivery nozzles, in accordance with various embodiments.

FIG. 4B shows how the internal distribution channels of the pyranometer assembly connecting the nozzles, in accordance with various embodiments.

FIG. 5A is an isometric view of a fluid-actuated moving fluid delivery nozzle assembly at rest, in accordance with various embodiments.

FIG. 5B is an orthogonal right-side view depicting the moveable delivery nozzle at the time fluid exits the nozzle, in accordance with various embodiments.

FIG. 5C is an isometric view of the moveable delivery nozzle after it has lifted off the lower stop and begun rotating counterclockwise about the rotational pivot, in accordance with various embodiments.

FIG. 5D is an orthogonal right-side view depicting the delivery nozzle after it has lifted off the lower stop and begun rotating counterclockwise about the rotational pivot, in accordance with various embodiments.

FIG. 5E is an isometric view of the moveable fluid delivery nozzle as it comes into contact with the upper stop, whereupon the reactive force of the exiting fluid holds the delivery nozzle in a fixed vertical position up against the upper stop, in accordance with various embodiments.

FIG. 5F is an orthogonal right-side view of the delivery nozzle as the nozzle comes into contact with the upper stop, whereupon the reactive force of the exiting fluid holds the delivery nozzle in a fixed vertical position up against the upper stop, in accordance with various embodiments.

FIG. 5G is an isometric view of the delivery nozzle immediately after liquid is no longer being dispensed by the delivery nozzle, in accordance with various embodiments.

FIG. 5H is an orthogonal right-side view of the delivery nozzle immediately after liquid is no longer being dispensed by the delivery nozzle, in accordance with various embodiments.

FIG. 6 depicts a process for cleaning radiometers using at least one of the cleaning systems described herein, in accordance with various embodiments.

### DETAILED DESCRIPTION

Systems and techniques are described herein for cleaning solar radiation sensors (e.g., radiometers) by directing one or more regulated streams of liquid (e.g., clean water or a cleaning solution) onto the outer surface of a sensor, and then directing one or more regulated streams of air onto the outer surface of the sensor. The outer surface may correspond to a light transmitting dome, window, light-accepting diffuser. Moreover, the streams of liquid and air can be sequentially applied as part of a timed, recurring, and/or automatic cleaning process. Radiometers are used for examples throughout the Detailed Description for the purpose of illustration only. One skilled in the art will recognize the systems and techniques described herein are equally applicable to other types of solar radiation sensors (e.g., pyranometers, quantum sensors, pyrheliometers, sun photometers, as well as devices such as photovoltaic reference cells.

The cleaning systems described herein can clean one or more solar radiometers for extended periods of time (e.g., six months or more) without requiring human interaction. Cleaning is accomplished by directing a stream of liquid at each radiometer, and then directing a stream of air at each radiometer to remove residual liquid and solid surface contaminants. The liquid could be clean water or a non-freezing cleaning solution, and the air may be filtered before being directed toward the radiometer. Each stream of liquid or air could be applied in a steady, pulsed, or swirling manner.

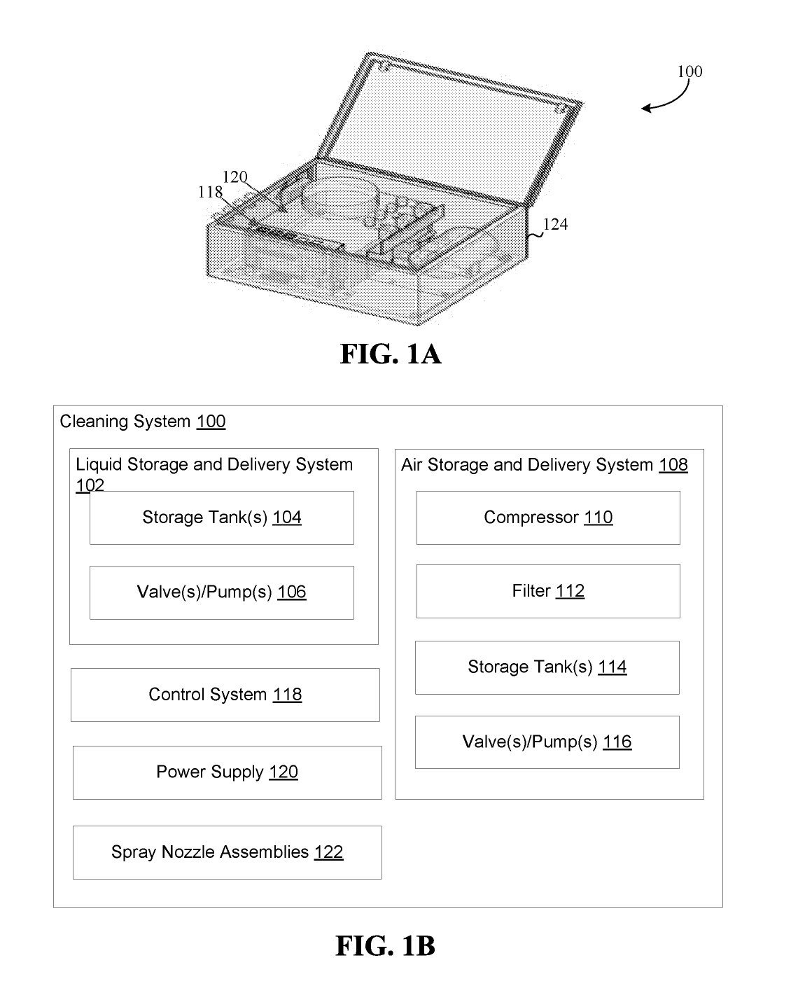

FIG. 1A depicts a delivery and control system (also referred to as a “cleaning system 100”) for cleaning solar radiometers, in accordance with various embodiments. The cleaning system 100 can include one or more delivery mechanisms and one or more storage systems housed within a protective mounting enclosure 124. Other components (e.g., a control system 118 and a power supply 120) may be included in some embodiments.

One or more solar power supply modules (e.g., solar panels) can be detachably or fixedly attached to the cleaning system 100. For example, a solar power supply module (not shown) could be affixed to the protective mounting enclosure 124 of the cleaning system 100.

The cleaning system 100 can include one or more storage tanks 104, 114 for holding liquids (e.g., water or cleaning solution) and/or air. The cleaning system 100 can control the flow of liquid or air from the storage tank(s) 104, 114 to one or more spray nozzle assemblies 122. For example, the storage tank(s) 104, 114 could be connected to the spray nozzle assemblies 122 by flexible or rigid tubing. As shown in FIG. 1B, in some embodiments the cleaning system 100 includes multiple distinct delivery systems for the liquid and air. That is, the cleaning system 100 can include a liquid storage and delivery system 102 and an air storage and delivery system 108, each of which may include distinct storage tank(s), valve(s), pump(s), etc.

FIG. 1B depicts a block diagram of components of the cleaning system 100, in accordance with various embodiments. The cleaning system 100 can include one or more storage tanks 104, 114, one or more valves and/or pumps 106, 116 for controlling the flow rate of liquid/air as it leaves the storage tank(s), a control system 118, a power supply 120, a compressor 110, and a filter 112. Other embodiments can include some or all of these components, as well as other components not shown here.

As noted above, the storage tank(s) 104, 114 can hold liquid (e.g., water or a cleaning solution) or air that is to be ejected across the surface of one or more solar radiometers. Valve(s) and/or pump(s) 106, 116 may be present that are sized and arranged to provide sufficient volumetric flow rates and fluid impingement velocities for effective debris and contaminant dislodgement and removal from the outer surfaces of the radiometer(s) to be cleaned. For example, pumps may be arranged so that liquid and air flow across the light-accepting optical elements of the radiometer(s).

The air storage and delivery system 108 can include a compressor 110, filter 112, storage tank(s) 114, and valve(s) and/or pump(s) 116 that can be used to deliver sufficient air flow to dry the radiometer(s). For example, the valve(s) and pump(s) 116 can be used to modify the air flow so that several solar radiometers can be dried simultaneously or sequentially. Valves for manual adjustment of air flow rate may also be provided along with normal provisions for pressure limitation, over-pressure relief, and manual depressurization.

The cleaning system 100 can employ periodic sequential operation of the liquid storage and delivery system 102 followed by operation of the air storage and delivery system 108. For example, the control system 118 may cause the liquid storage and delivery system 102 to eject a liquid (e.g., water or a cleaning solution) onto the surface of a radiometer, and then cause the air storage and delivery system 108 to eject air onto the surface of the solar radiometer to remove any residual liquid and solid surface contaminants. Operation of the liquid storage and delivery system 102 can be suppressed by the control system 118 when the liquid storage tank(s) 104 become depleted or when predefined temporal or environmental conditions are met (e.g., a time limit has been exceeded).

The control system 118 can provide timing, sequencing, and electrical switching functions for both the liquid and air storage and delivery systems 102, 108. In some embodiments, the time between cleaning operations is manually adjustable (e.g., by an operator of the cleaning system 100). For example, the time may be adjustable from 1 to 96 hours through use of a manual push-button-adjustable potentiometer that includes a digital display. Pump and compressor run time (which is typically measured in seconds) can be similarly and separately adjusted with distinct manually adjustable push-button digital displays. The push button components enable manual control of system timings without the need to employ electronic interface devices to change the primary controlling timing settings of the liquid and air storage and delivery systems 102, 108.

Various embodiments may also include one or more power supplies (e.g., including the power supply 120). For example, solar photovoltaic power supplies may be included that enable autonomous operation without requiring external connections other than to an electrical ground, which is typically available through the host measurement system (i.e., the radiometer). As another example, the cleaning system 100 may include batteries and/or a mechanical power interface for connecting to an external power source, such as a plug or jack.

One or more spray nozzle assemblies 122 are connected to the liquid and/or air storage delivery system 102, 108 and are used to eject liquid and air onto the surface of one or more radiometers. Different spray nozzle assembly designs are contemplated for different solar radiometer types and installation configurations.

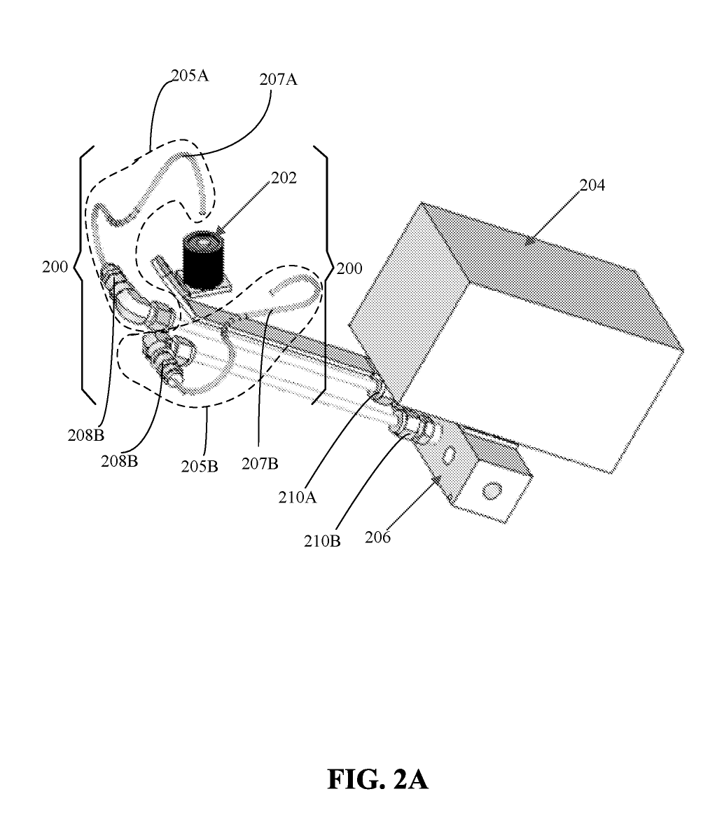

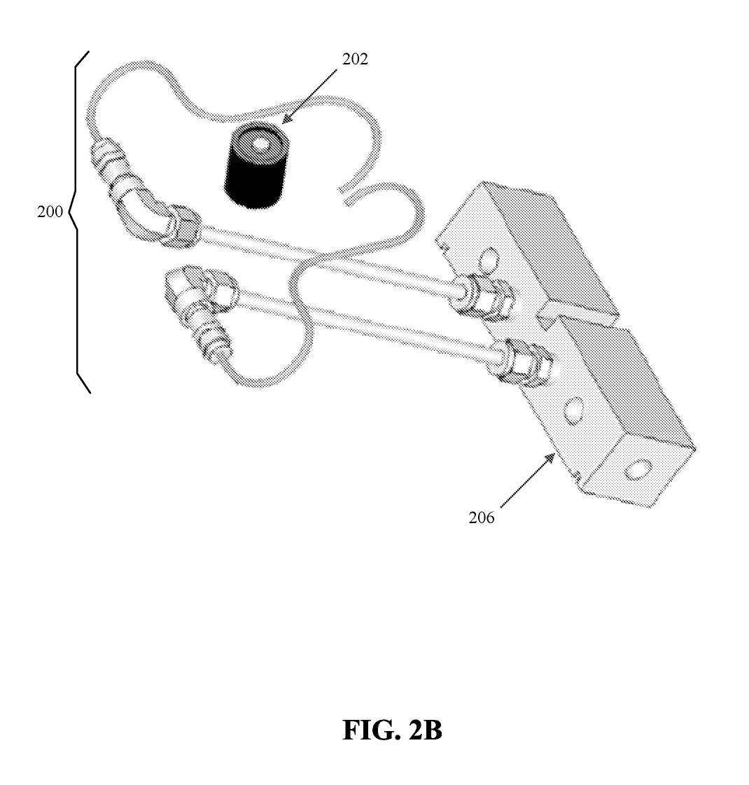

FIG. 2A depicts a spray nozzle assembly 200 for cleaning a photodiode pyranometer 202 shown in its mounting position affixed to the underside of the pyranometer's combination motor housing 204 and photodiode pyranometer mounting arm 206, in accordance with various embodiments. FIG. 2B depicts the spray nozzle assembly 200 for cleaning the photodiode pyranometer 202 without showing the pyranometer's combination motor housing 204, in accordance with various embodiments.

The spray nozzle assembly 200 can include a first cleaner portion 205A and a second cleaner portion 205B. The first cleaner portion 205A can include a first nozzle 207A affixed to a rotatable pivot 208A. The rotatable pivot 208A can be affixed to a valve 210A that provides fluid to the first nozzle 207A. The second cleaner portion 205B can include a second nozzle 207B affixed to a rotatable pivot 208B. The rotatable pivot 208B can be affixed to a valve 210B that provides fluid to the second nozzle 207B.

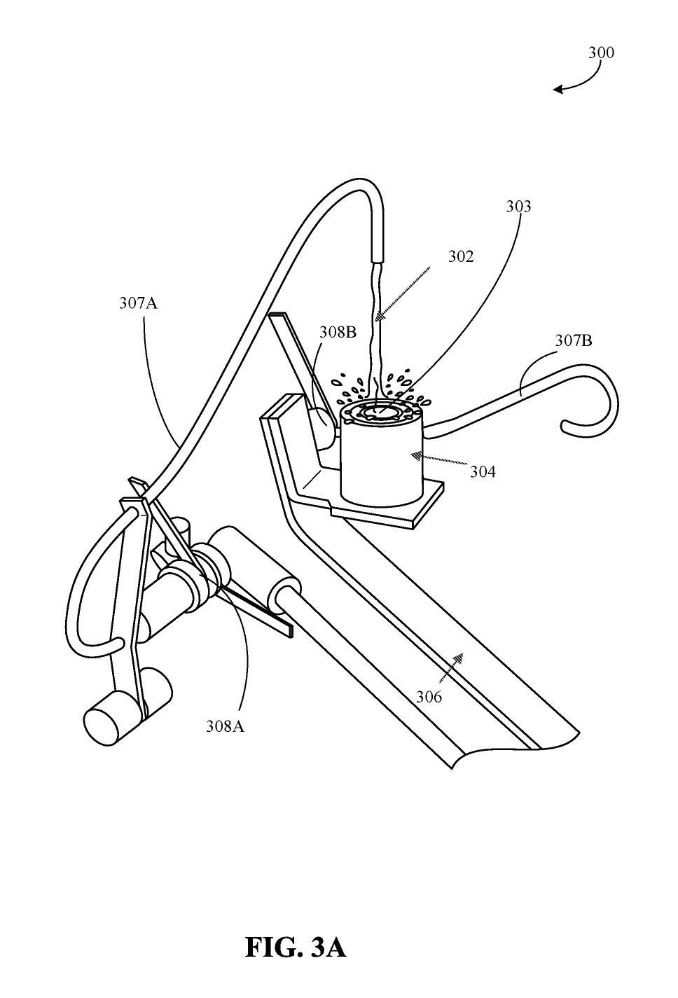

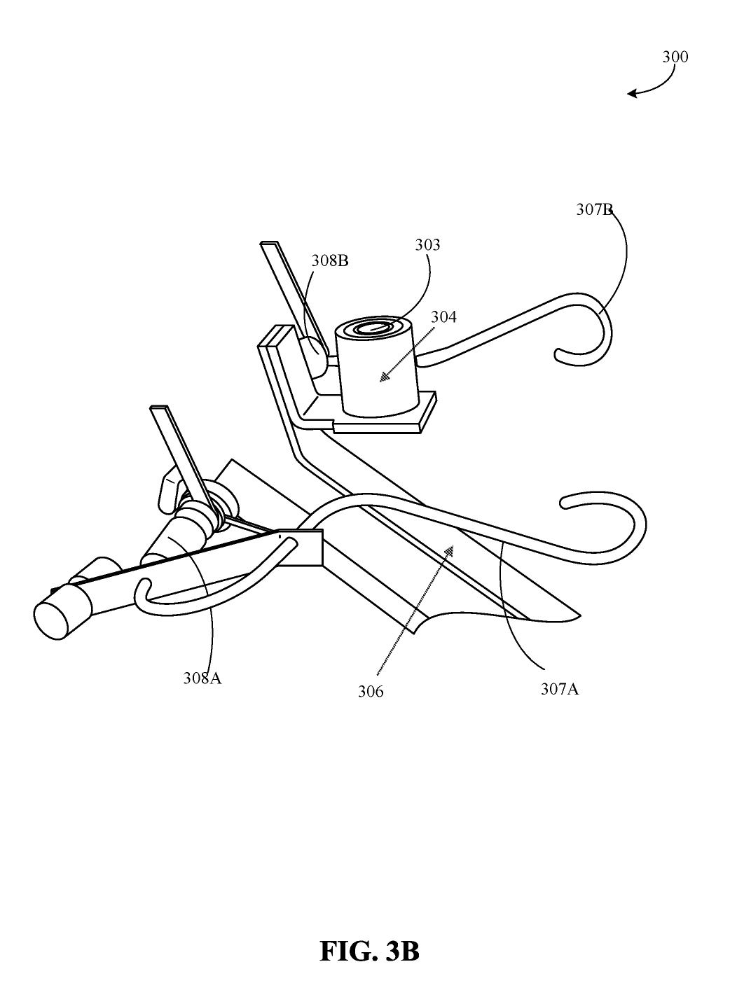

As shown in FIGS. 2A-B, the spray nozzle assembly 200 for pyranometer-based rotating shadow band radiometers may include a combination liquid and air distribution header and connected fluid fittings and conduits extending to one or more fluid channeling fittings. Here, for example, liquid and air are dispensed via separate dispensing nozzles. The fittings and conduits may also form the rotational pivoting base for multi-position, dynamically-actuated dispensing nozzles as shown in FIGS. 3A-B. Additional implementations of similar designs using electro-mechanical nozzle movement are also contemplated and, in some instances, may be desirable.

FIG. 3A depicts a spray nozzle assembly 300 that is delivering a single, steady stream of liquid 302 to a light-accepting diffuser 303 of a photodiode pyranometer 304, in accordance with various embodiments. The spray nozzle assembly 300 is arranged above the photodiode pyranometer 304 within a rotating shadow band radiometer. The spray nozzle assembly 300 can be affixed to the underside of a radiometer's combination motor housing (not shown) and photodiode pyranometer mounting arm 306, which allows the stream of liquid 302 to be delivered directly to the light-accepting diffuser 303 of the photodiode pyranometer 304. The spray nozzle assembly 300 can include a first cleaner portion and a second cleaner portion. The first cleaner portion can include a first nozzle 307A affixed to a rotatable pivot 308A. The second cleaner portion can include a second nozzle 307B affixed to a rotatable pivot 308B.

FIG. 3B depicts the spray nozzle assembly 300 for cleaning the photodiode pyranometer 304 after liquid delivery has been completed, in accordance with various embodiments. As shown, the rightmost moveable nozzle 307 has begun its movement into position to eject air to dislodge residual liquid deposited on the photodiode pyranometer 304 during the liquid delivery phase. As noted above, the pressure of the air within the rightmost nozzle may cause the nozzle 307 to become positioned above the light-accepting diffuser 303 of the photodiode pyranometer 304.

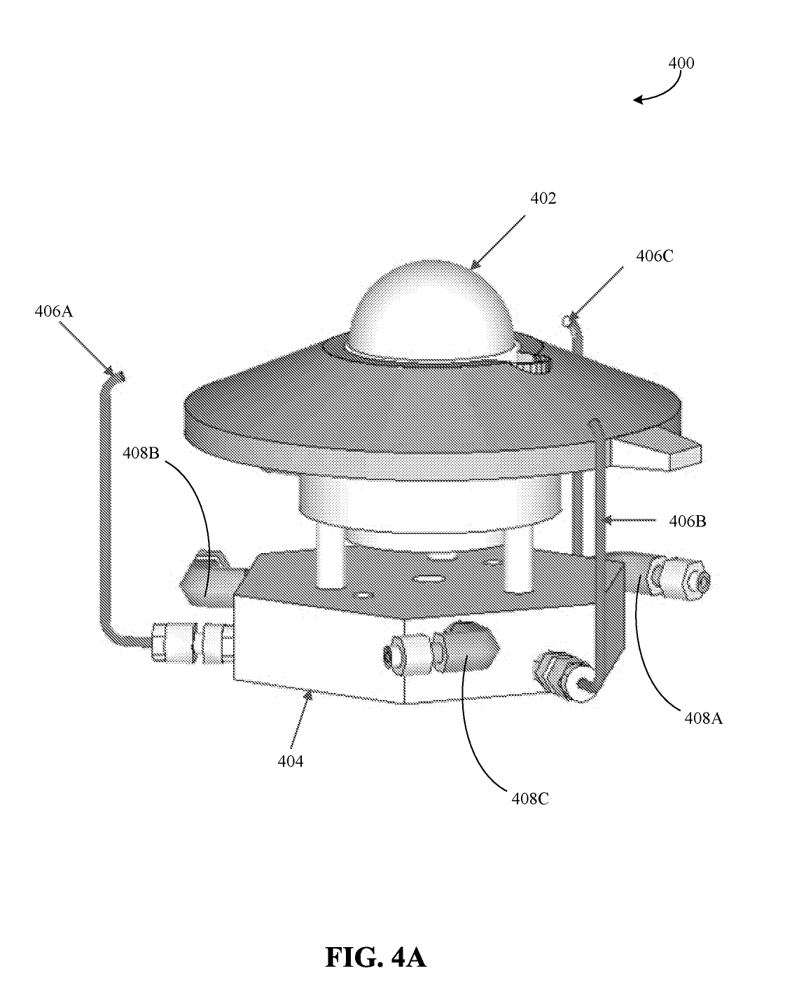

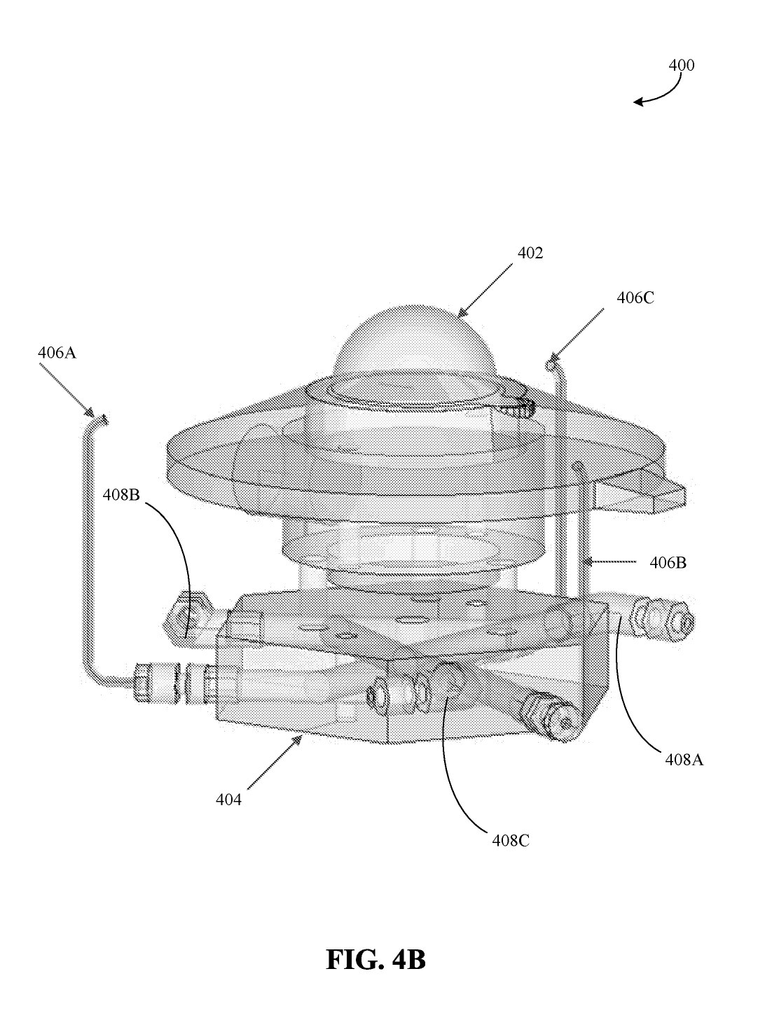

The spray nozzle assembles described herein could also be used with glass-domed or quartz-domed thermopile-type pyranometer radiometers. For example, FIGS. 4A-B depict a spray nozzle assembly that includes multi-channel fluid distribution blocks.

FIG. 4A depicts a pyranometer assembly 400 including a thermopile pyranometer 402 mounted on an azimuthally-orientable and level-adjustable base block 404 having nozzles (e.g., a nozzle 406A, a nozzle 406B, and a nozzle 406C, collectively as the “nozzles 406”), in accordance with various embodiments. The nozzles 406 can be fixed delivery nozzles. The nozzles 406 can be respectively supplied by intake valves 408 (e.g., an intake valve 408A, an intake valve 408B, and an intake valve 408C, collectively as the “intake valves 408”). In some embodiments, the intake valves 408 control an external supply of fluid to the nozzles 406. In some embodiments, the intake valves 408 include storage space to store an external supply of fluid and can release the stored fluid to the nozzles 406 upon command (e.g., responsive to a command from the control system 118 to the pumps/valves 106 or the pumps/valves 116).

FIG. 4B shows how the internal distribution channels of the pyranometer assembly 400 connecting the nozzles 406, in accordance with various embodiments. The pyranometer assembly 400 can provide multiple functions including:
Air and liquid distribution to one or more fixed or moveable (e.g., via fluid-dynamics or electro-mechanical actuation) liquid and air delivery nozzles;
Secure mechanical attachment of the pyranometer body by threaded screw connection to the base block;
Adjustment of the azimuthal orientation of the base block and attached radiometer; and
Adjustment of the level or tilt of the base block and attached radiometer.

In some embodiments, one or more nozzles for delivering air are also attached to the base block 404 of the thermopile pyranometer 402. The air delivery nozzles may be movable between different positions. For example, the air delivery nozzles could move between a rest position in which the nozzles reside below the horizontal field of view of the thermopile pyranometer 402 and a use position in which the air delivery nozzles are pointed toward the thermopile pyranometer 402. In various other embodiments, other spray nozzle assembly designs can be used with other radiometer types, including but not limited to thermopile-based and photodiode-based pyrheliometer radiometers.

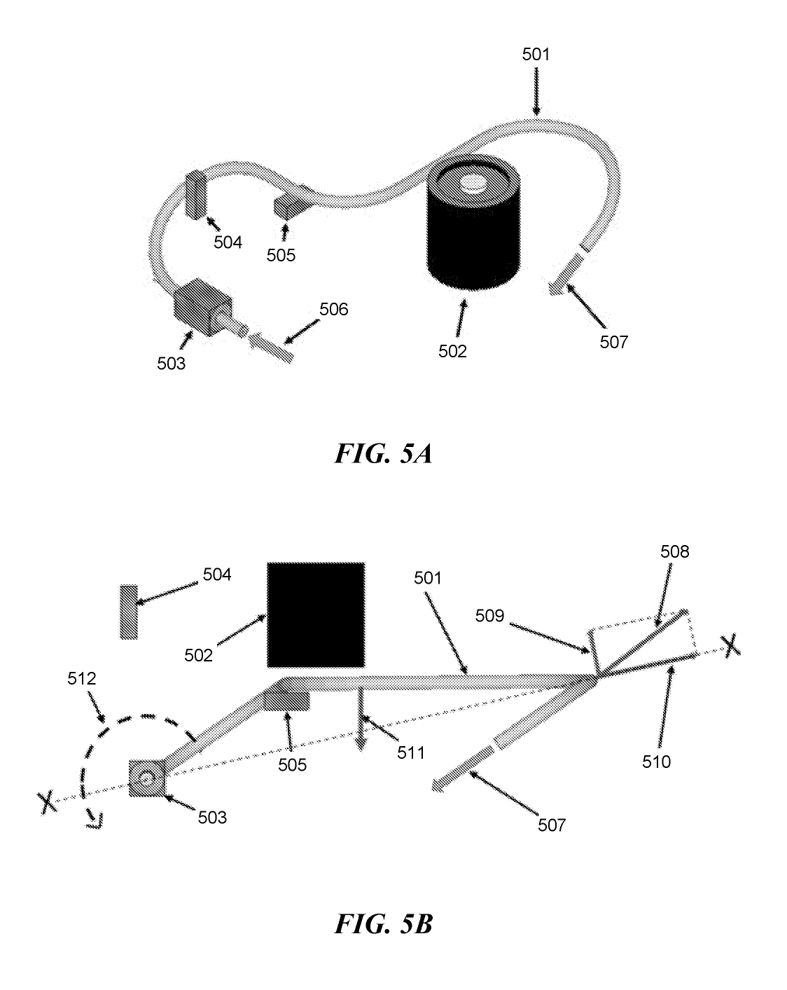

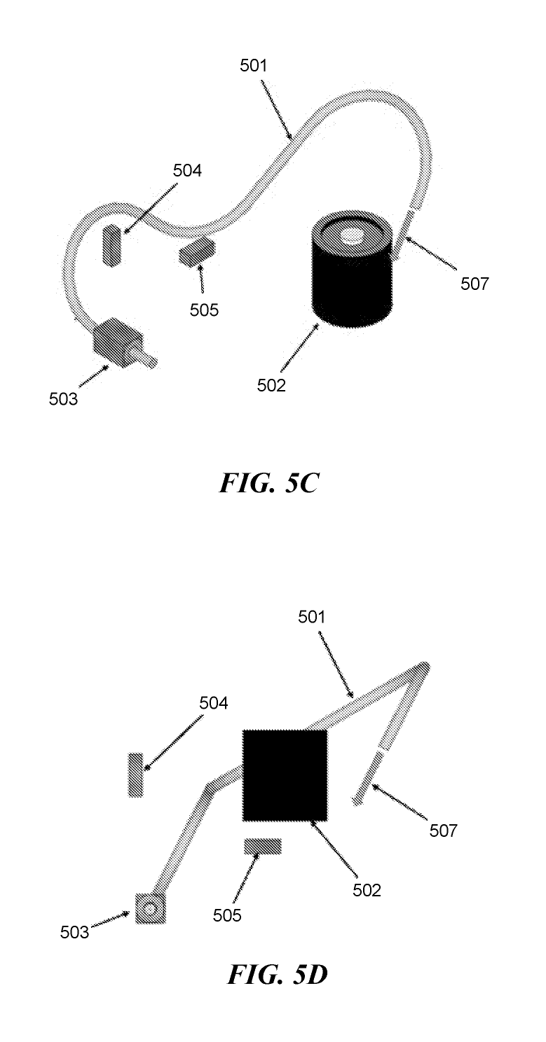

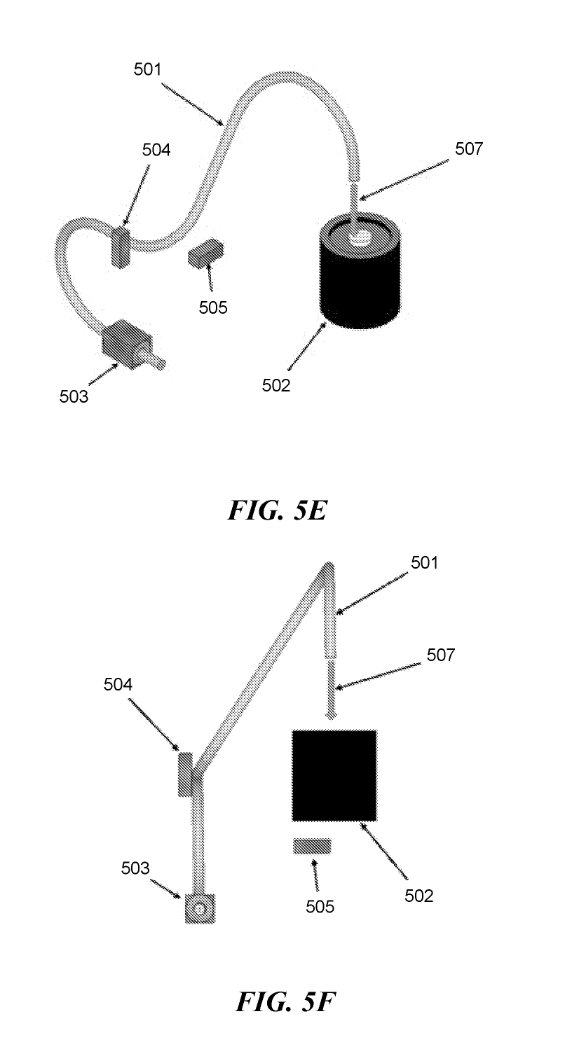

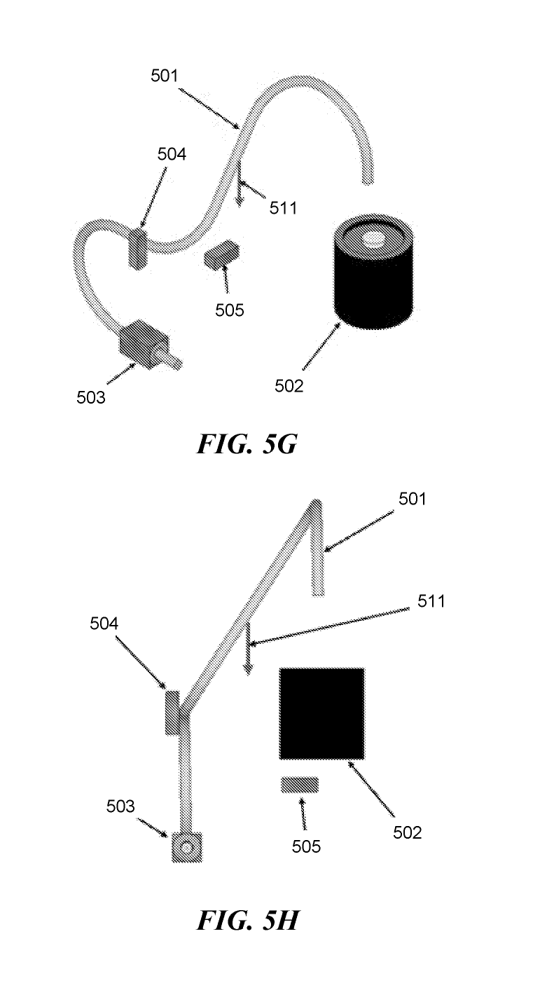

FIGS. 5A-H illustrate various operational principles of a delivery mechanism that changes positon during a cleaning operation to deliver air or liquid (e.g., water or a cleaning fluid) from an angle providing a higher cleaning effectiveness. The delivery mechanism may reside on a certain position when not in use that does not occlude any portion of a radiometer's field of view.

The motion of the delivery mechanism can be driven by either the dynamic forces generated by the fluid (i.e., air or liquid) exiting a nozzle or by electro-mechanical means. For example, a fluid-actuated nozzle mechanism may be used in combination with radiometers having full hemispherical radiation acceptance angles mounted horizontally or at tilt. When not in use, the nozzle of the delivery mechanism may rest entirely below and outside the radiometer's field of view. During a cleaning process, the nozzle can be moved into a cleaning position from which the nozzle directs one or more streams (e.g., streams of air, water, or a cleaning solution) downward at the radiometer's dome or diffuser at an angle that effects thorough surface cleaning. The tubular portion of the delivery mechanism for transporting fluid can be shaped and constrained in such a way as to permit the force caused by the reactive fluid dynamic thrust of the fluid exiting the nozzle to initiate rotation of the tubular portion about a bearing as shown in FIGS. 5A-H.

FIG. 5A is an isometric view of a solar sensor cleaning system 500 with a delivery mechanism at rest, in accordance with various embodiments. More specifically, FIG. 5A depicts a movable delivery nozzle 501 that is at rest. The moveable delivery nozzle 501 can be positioned adjacent to a pyranometer 502. The pyranometer 502 can be a photodiode-type radiometer. The delivery nozzle 501 can rotate about a rotational pivot 503 (e.g., a bearing), while an upper stop 504 and lower stop 505 may limit the rotational range. The upper and lower stops 504 and 505 may physically prevent the delivery nozzle 501 from rotating past a certain point. As shown in FIG. 5A, fluid can enter the delivery mechanism at point 506 and exit the delivery nozzle 501 at point 507.

FIG. 5B is an orthogonal front view depicting the delivery nozzle 501 at the time fluid exits the nozzle at point 507, in accordance with various embodiments. When fluid exits the nozzle, a force 508 acts on the delivery nozzle 501 opposite in direction to the exiting fluid flow. The force 508 is orthogonally resolved along and perpendicular to axis X-X′ into forces 509 and 510. When the vertical resolution 509 of the force 508 exceeds the force 511 caused by the weight of the delivery nozzle 501 and contained fluid, the delivery nozzle 501 is lifted from the lower stop 505 and rotates about the rotational pivot 503 in the direction indicated by arc 512.

FIG. 5C is an isometric view of the delivery nozzle 501 after it has lifted off the lower stop 505 and begun rotating counterclockwise about the rotational pivot 503, in accordance with various embodiments. FIG. 5D is an orthogonal front view depicting the delivery nozzle 501 after it has lifted off the lower stop 505 and begun rotating counterclockwise about the rotational pivot 503, in accordance with various embodiments.

FIG. 5E is an isometric view of the delivery nozzle 501 as the delivery nozzle 501 comes into contact with the upper stop 504, whereupon the reactive force of the fluid exiting at point 507 holds the delivery nozzle 501 in a fixed vertical position up against the upper stop 504, in accordance with various embodiments. FIG. 5F is an orthogonal right-side view of the delivery nozzle 501 as the nozzle comes into contact with the upper stop 504, whereupon the reactive force of the fluid exiting the point 507 holds the delivery nozzle 501 in a fixed vertical position up against the upper stop 504, in accordance with various embodiments. Once positioned in such a manner, the delivery nozzle 501 can continue to direct fluid vertically downward onto the light-accepting diffuser of the pyranometer 502 until the controller of the cleaning system terminates the power being supplied to the pump responsible for causing the fluid to flow.

FIG. 5G is an isometric view of the delivery nozzle 501 immediately after liquid is no longer being dispensed by the delivery nozzle 501, in accordance with various embodiments. FIG. 5H is an orthogonal right-side view of the delivery nozzle 501 immediately after liquid is no longer being dispensed by the delivery nozzle 501, in accordance with various embodiments. When fluid is no longer being pumped from the delivery nozzle 501, the gravitational force 5011 produced by the weight of the delivery nozzle 501 and any contained fluid is vertically unopposed and causes the delivery nozzle 501 to fall back to its original resting position (e.g., against the lower stop 505). The delivery nozzle 501 will typically rest below and out of the pyranometer's field of view at such time.

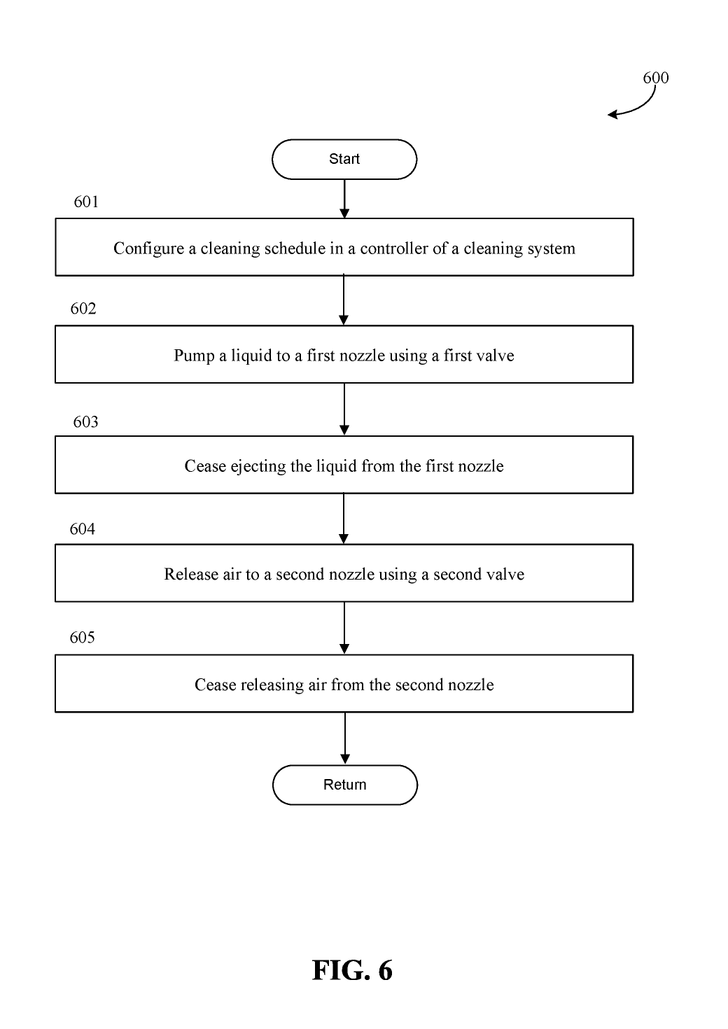

FIG. 6 depicts a process 600 for cleaning radiometers using a cleaning system (e.g., cleaning system 100 of FIG. 1). A cleaning schedule can be initially configured by a controller (e.g., the control system 118) of the cleaning system (step 601). For example, the cleaning schedule could be programmatically entered by an operator of the cleaning system. Alternatively, the cleaning schedule could be manually specified by providing input (e.g., using mechanical buttons or a user interface) at the cleaning system. The cleaning schedule specifies details regarding a cleaning process for washing one or more radiometers simultaneously or sequentially. The cleaning schedule typically requires the cleaning system alternate between washing the radiometer with a liquid (e.g., water or a cleaning solution) and blow drying the radiometer with compressed air to remove residual liquid and solid surface contaminants.

Based on the cleaning schedule, the cleaning system can pump the liquid via a first valve to a first nozzle arranged over the radiometer (step 602). The first nozzle may be pivotably attached to the base of the radiometer. In such embodiments, pumping of the liquid may create sufficient pressure to rotationally propel the first nozzle around a pivot until the first nozzle is arranged over the radiometer.

The cleaning system can then cease ejecting the liquid from the first nozzle (step 603). In some embodiments, the gravitational force produced by the first nozzle and any liquid contained within the first nozzle causes the first nozzle to rotate about the pivot back to its original position (e.g., against a physical lower stop) when liquid is no longer being dispensed.

The cleaning system can release compressed air via a second valve to a second nozzle arranged over the solar radiometer in order to remove residual liquid from the surface of the radiometer (step 604). The second nozzle may also be pivotably attached to the base of the radiometer. In such embodiments, the compressed air may create sufficient pressure to rotationally propel the second nozzle around a pivot until the second nozzle is arranged over the radiometer.

The cleaning system can then cease releasing air from the second nozzle (step 605). The gravitational force produced by the second nozzle may cause the second nozzle to rotate about the pivot back to its original position (e.g., against a physical lower stop) when air is no longer being released. Thus, both the first and second nozzles may be positioned outside of the solar radiometer's point of view when the cleaning process is not being performed.

Unless contrary to physical possibility, it is envisioned that the steps described above may be performed in various sequences and combinations. For example, the cleaning schedule may require that fluid and air be alternately applied to the surface of the radiometer over a certain period of time or for a certain number of cycles. Additional steps could also be included in some embodiments.

Moreover, in addition to the above mentioned examples, various other modifications and alterations of the invention may be made without departing from the invention. Accordingly, the above disclosure is not to be considered as limiting and the appended claims are to be interpreted as encompassing the true spirit and the entire scope of the invention.

What is claimed is:

1. A spray nozzle assembly for cleaning a solar sensor, the spray nozzle assembly comprising:
a nozzle for delivering a fluid to a surface of the solar sensor,
wherein the nozzle is configured to use the reactive force caused by moving fluid exiting the nozzle to move the nozzle into a delivery position, and
wherein the nozzle is configured to use gravity to restore the nozzle to an inactive position upon cessation of fluid flow; and
a pivot anchor for securing one end of the nozzle adjacent to the solar sensor,
wherein the pivot anchor enables the nozzle to rotate about a pivot point when moving between the delivery position and the inactive position.

2. The spray nozzle assembly of claim 1, wherein the fluid is air or a liquid.

3. The spray nozzle assembly of claim 1, wherein the nozzle is shaped to direct the fluid such that the fluid exiting the nozzle creates a reactive force to rotate the nozzle about the pivot point of the pivot anchor.

4. The spray nozzle assembly of claim 1, further comprising:
an electro-mechanical mechanism for controllably position the nozzle and delivering the fluid from a fluid delivery system to the sensor's light accepting surface(s),
wherein the valve is configured to be opened by an electronic control system in accordance with a periodic schedule.

5. The spray nozzle assembly of claim 4, wherein the valve and the nozzle are configured to deliver a steady flow of the fluid.

6. The spray nozzle assembly of claim 4, wherein the valve and the nozzle are configured to deliver the fluid in pulses.

7. The spray nozzle assembly of claim 1, wherein the nozzle is configured to swirl while delivering the fluid.

8. The spray nozzle assembly of claim 1, wherein the spray nozzle assembly is configured to remain outside a field of view of the solar sensor when in the inactive position.

9. The spray nozzle assembly of claim 1, wherein the nozzle is a first nozzle for delivering a liquid to the surface of the solar sensor.

10. The spray nozzle assembly of claim 9, further comprising:
a second nozzle for delivering air to the surface of the solar sensor.

11. The spray nozzle assembly of claim 10, wherein the second nozzle is configured to deliver air to the surface of the solar sensor after the first nozzle delivers the liquid to the surface of the solar sensor.

12. The spray nozzle assembly of claim 10, wherein the first nozzle and the second nozzle are positioned adjacent to the solar sensor and outside of a field of view of the solar sensor when in the inactive position.

13. The spray nozzle assembly of claim 1, further comprising:
a mounting component for securely fastening the spray nozzle assembly to a base plate of the solar sensor.

14. The spray nozzle assembly of claim 13, wherein the mounting component is configured to enable external leveling and azimuthal adjusting of the solar sensor.

15. A system for cleaning solar sensors, the system comprising:
a first nozzle for delivering a liquid to a surface of a solar sensor;
a first valve for controllably delivering the liquid from a first storage tank to the first nozzle;
a first pivot anchor for attaching one end of the first nozzle to the solar sensor,
wherein the first pivot anchor enables the first nozzle to rotate about a first pivot point when moving between a delivery position and an inactive position; and
an enclosure for housing the first storage tank and the first valve.

16. The system of claim 15, further comprising:
a second nozzle for delivering air to the surface of the solar sensor,
wherein the second nozzle is configured to use a reactive force caused by moving air within the second nozzle to move the second nozzle into a delivery position, and
wherein the second nozzle is configured to use gravity to restore the second nozzle to an inactive position;
a second valve for controllably releasing air from a second storage tank to the second nozzle; and
a second pivot anchor for attaching one end of the second nozzle to the solar sensor,
wherein the second pivot anchor allows the second nozzle to rotate about a second pivot point when moving between the delivery position and the inactive position.

17. The system of claim 16, further comprising:
a controller for alternately causing the first and second nozzles to move into the delivery position.

18. The system of claim 15, wherein the first nozzle is configured to use a reactive force caused by moving liquid within the first nozzle to move the first nozzle into a delivery position, and wherein the first nozzle is configured to use gravity to restore the first nozzle to an inactive position.

19. The system of claim 15, further comprising an electro-mechanical device configured to move the first nozzle into a delivery position, and wherein the electro-mechanical device is configured restore the first nozzle to an inactive position once cleaning is completed.

20. A method of operating a cleaning system for cleaning a solar sensor, the method comprising:
configuring a cleaning schedule in a controller of the cleaning system, wherein the cleaning schedule specifies a schedule for washing the solar sensor with a liquid and drying the solar sensor with compressed air;
based on the cleaning schedule,
pumping the liquid to a first nozzle that is pivotably attached to a base of the solar sensor,
wherein said pumping is performed with sufficient pressure to rotate the first nozzle around a first pivot until the first nozzle is arranged over the solar sensor; and
releasing the compressed air to a second nozzle that is pivotably attached to the base of the solar sensor,
wherein said releasing of the compressed air generates sufficient pressure to propel the second nozzle around a second pivot until the second nozzle is arranged over the solar sensor.

21. The method of claim 20, further comprising:
based on the cleaning schedule,
ceasing to pump the liquid to the first nozzle,
wherein discontinuing to pump the liquid to the first nozzle causes the first nozzle to rotate around the first pivot until the first nozzle is outside of a field of view of the solar sensor; and
ceasing to release the compressed air to the second nozzle,
wherein discontinuing to release the compressed air to the second nozzle causes the second nozzle to rotate around the second pivot until the second nozzle is outside of the field of view of the solar sensor.

22. The method of claim 20, wherein the liquid is water or a cleaning solution.

23. The method of claim 20, wherein the cleaning schedule specifies that cleaning is to be performed periodically.

24. The method of claim 20, further comprising:
prior to releasing the compressed air to the second nozzle, filtering the compressed air.
